(19) United States
(12) Patent Application Publication
(10) Pub. No.: US 2016/0187510 A1
(43) Pub. Date: Jun. 30, 2016

(54) METHODS AND SYSTEMS FOR MONITORING A TARGET USING REFRACTION DATA ACQUIRED WITH BURIED SOURCES AND BURIED SENSORS

(71) Applicant: CGG SERVICES SA, Massy (FR)

(72) Inventors: Julien COTTON, Paris (FR); Eric FORGUES, Bures-sur-Yvette (FR)

(21) Appl. No.: 14/908,737

(22) PCT Filed: Jul. 30, 2014
(86) PCT No.: PCT/EP2014/066428

§ 371 Date: Jan. 29, 2016

Related U.S. Application Data
(60) Provisional application No. 62/001,865, filed on May 22, 2014.
(60) Provisional application No. 61/861,030, filed on Aug. 1, 2013.

(51) Int. Cl. G01V 1/30; G01V 1/00

(52) U.S. Cl. CPC G01V 1/308; G01V 1/003; G01V 2210/1299; G01V 2210/1429; G01V 2210/612

(57) ABSTRACT

Methods and systems for monitoring a target volume are characterized by having sources and detectors buried under the weathering layer and comparing data corresponding to refracted waves acquired during different surveys to infer changes in the target volume, wherein locations of sources and detectors are the same for the different surveys.

### CROSS REFERENCE TO RELATED APPLICATIONS

This application claims priority and benefit from U.S. Provisional Patent Application No. 61/861,030, filed Aug. 1, 2013, for “Reservoir Monitoring by Seismic Refraction Using Buried Sources and/or Buried Sensors,” and U.S. Provisional Patent Application No. 62/001,865, filed May 22, 2014, for “Reservoir Monitoring by Seismic Refraction Using Buried Sources and/or Buried Sensors,” the entire contents of which are incorporated in their entirety herein by reference.

### BACKGROUND

1. Technical Field

Embodiments of the subject matter disclosed herein generally relate to monitoring a target volume or, more specifically, to using refracted data to estimate changes in a target volume between different surveys.

2. Discussion of the Background

In geophysical prospecting, gas and oil reservoirs are sought by performing seismic surveys of sedimentary rock formations using variations of seismic wave propagation velocity from one layer to another. Reflected, refracted and transmitted waves are detected by seismic receivers after traveling through an explored formation.

Hydrocarbon reservoir surveillance during production is a tool employed to reduce operating costs and maximize recovery of oil and/or gas. Time-lapse (4D) seismic methods use seismic surveys performed during distinct survey periods to monitor changes in the reservoir during production. Seismic velocity and density of a formation, including a producing reservoir, depend on rock type and fluid properties. Changes in seismic responses between surveys may be caused by changes in reservoir saturation, pore fluid pressure during fluid injection or depletion, fractures, temperature changes, etc.

Imaging the underground formation using reflected waves is a well-established technique, but it has some significant drawbacks. Multiple reflections and reverberations make it difficult to achieve a reasonable signal-to-noise ratio. The signal-to-noise ratio is enhanced through expensive high-fold acquisitions (thereby extending data acquisition time) and complex data processing.

Monitoring using refracted waves is a simpler method, with the refracted waves focusing on a target surface or profile, rather than carrying information about layers beneath the reservoir. In a favorable geological context, (e.g., a heavy oil reservoir in Alberta, Canada, as described in “Time-lapse Refraction Seismic Monitoring” included in proceedings of the 72^{nd} EAGE Conference & Exhibition incorporating SPE EUROPEC 2010 Barcelona, Spain, 14-17 Jun. 2010, the entire contents of which is incorporated herein by reference) monitoring using refracted waves is less susceptible to ground-roll and multiples than monitoring using reflected waves. With the signal-to-noise ratio for refracted data being substantively greater than for reflected data, monitoring using refracted data requires a shorter survey time and simpler data processing.

As illustrated in FIG. 1, refracted seismic data has conventionally been acquired using sources and detectors placed on the earth's surface. Thus, a surface source 110 emits seismic waves 120 that penetrate the weathering layer 130, other layers 135 between earth surface 115, and a targeted reservoir 140. Unlike the deeper layers 135, weathering layer 130 is affected by climatic changes (temperature, humidity, etc.). Waves having a predetermined angle are subject to critical refraction at the reservoir's bottom surface 145 and, therefore, do not penetrate under the reservoir 140. Refracted waves 125 (only two labeled) return from the reservoir's bottom surface 145, up toward the earth's surface 115, where they are received by seismic detectors 150.

This arrangement for acquiring refracted seismic data, with sources and receivers placed at the earth's surface, renders conventional seismic refraction insufficiently repeatable for observing weak 4D variations. The poor repeatability is due to positioning errors from one survey to another (i.e., variability of the acquisition geometry), variations of the weathering layer between surveys, and surface-related noise.

Accordingly, it is desirable to develop methods and seismic monitoring systems able to acquire refracted seismic data while mitigating the above-identified drawbacks of conventional methods.

### SUMMARY

A seismic survey system observing refracted waves is set up under the weathering layer to monitor evolution of an underground formation. Unlike conventional systems, this manner of monitoring avoids variations due to the weathering layer and, unlike observing reflected waves, refracted waves require less data, and data is processed faster and easier.

According to an embodiment, there is a method for monitoring a target volume. The method includes deploying one or more reusable seismic sources and one or more seismic detectors under the weathering layer so that seismic waves emitted by the one or more seismic sources propagate through the target volume before reaching the one or more seismic detectors. The method further includes obtaining a first refracted dataset during a first survey using the one or more seismic detectors and the one or more seismic sources, obtaining a second refracted dataset during a second survey using the one or more seismic detectors and the one or more seismic sources, and comparing the first refracted dataset with the second refracted dataset to estimate changes inside the target volume between the first survey and the second survey. The locations of the one or more seismic sources and of the one or more seismic detectors are the same for the first survey and for the second survey.

According to another embodiment there is a monitoring system including one or more seismic sources and one or more seismic detectors deployed so that seismic waves emitted by the one or more seismic sources propagate through a target volume before reaching the one or more seismic detectors. The monitoring system also includes a seismic data processing unit configured to receive a first seismic dataset obtained during a first survey using the one or more seismic detectors and the one or more seismic sources, and a second seismic dataset obtained during a second survey using the one or more seismic detectors and the one or more seismic sources, to extract a first refracted dataset from the first seismic dataset and a second refracted dataset from the second seismic dataset, and to compare the first refracted dataset with the second refracted dataset to estimate an evolution of the target volume. The locations of the one or more seismic sources and of the one or more seismic detectors are not changed between the first survey and the second survey.

According to yet another embodiment, there is a non-transitory computer readable medium storing executable codes which, when executed by a processor that receives a first seismic dataset obtained during a first survey using the one or more seismic detectors and the one or more seismic sources arranged so that seismic waves emitted by the one or more seismic sources travel through a target volume before reaching the one or more seismic detectors, and a second dataset obtained during a second survey using the one or more seismic detectors and the one or more seismic sources which have the same location as during the first seismic survey, makes the processor perform a method for monitoring a target volume. The method includes extracting a first refracted dataset from the first seismic dataset and a second refracted dataset from the second dataset, and comparing the first refracted dataset with the second refracted dataset to estimate changes that occurred inside the target volume between the first survey and the second survey.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a conventional system for acquiring seismic refracted data;

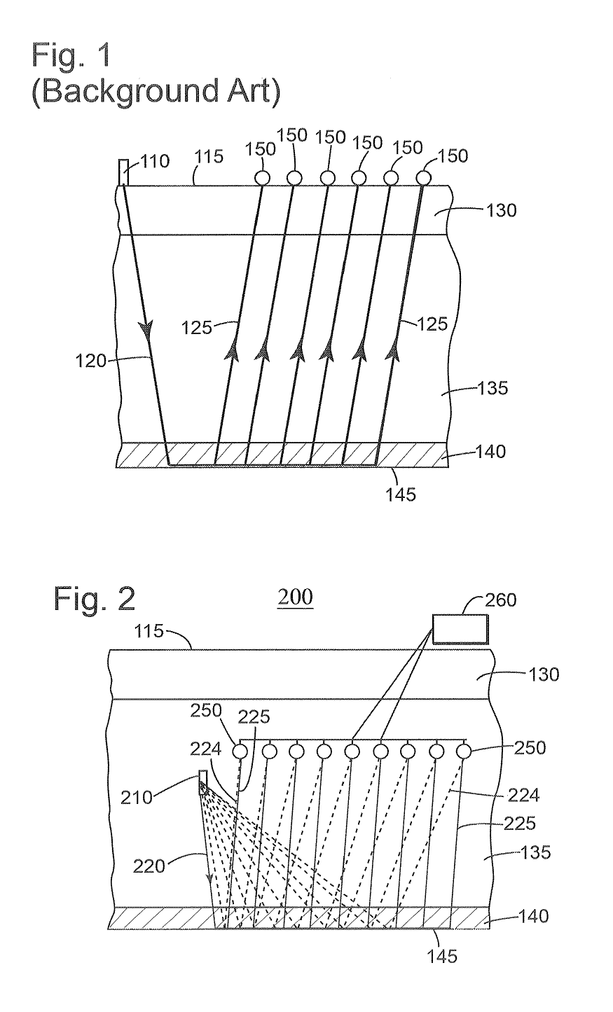

FIG. 2 illustrates a seismic survey system according to an embodiment;

FIG. 3 illustrates a seismic source usable in the seismic system of FIG. 2;

FIG. 4 illustrates a data processing unit according to an embodiment;

FIG. 5 is a flowchart of a method for monitoring an underground formation according to an embodiment;

FIGS. 6A-C, 7A-C and 8A-C are graphs illustrating simulated refracted datasets; and

FIG. 9 is a flowchart of a method according to another embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to land seismic data acquisition. However, similar embodiments and methods may be used for a marine data acquisition system and for surveys using electromagnetic waves.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

In order to mitigate problems observed in conventional refracted data acquisition systems, methods and systems according to various embodiments deploy one or more seismic sources and one or more seismic detectors under the weathering layer. The source(s) and sensor(s), which are not moved between surveys, are arranged so that seismic waves emitted by the source(s) propagate through a target volume (e.g., to and through an oil and gas reservoir) and suffer critical refraction at an interface therein. Changes inside the target volume between surveys are estimated by comparing refracted datasets extracted from seismic datasets acquired during surveys done at different times.

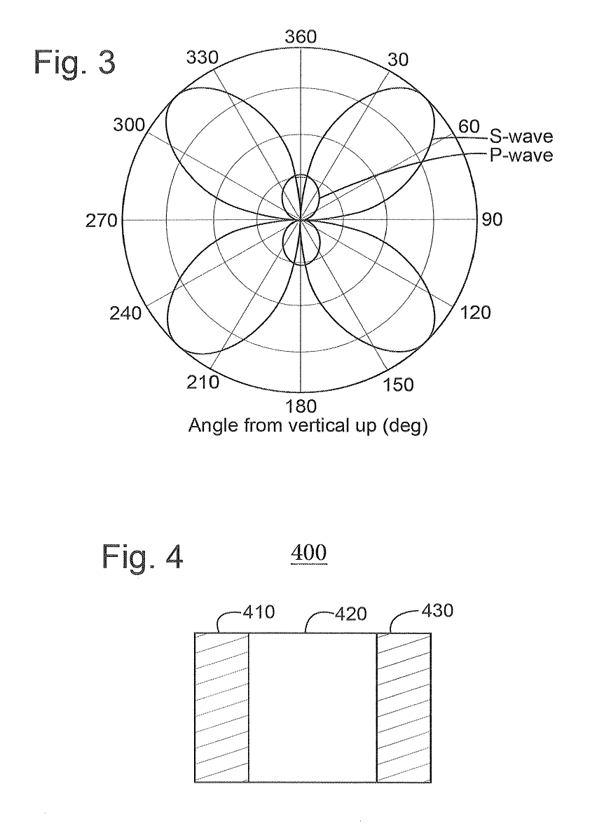

FIG. 2 illustrates a monitoring system 200 according to an embodiment. The monitoring system may include plural sources, but only source 210 is illustrated in FIG. 2, and may include only one seismic detector, although plural seismic detectors 250 are illustrated in FIG. 2. Note that the sources are reusable sources, unlike dynamite which cannot be fired two times. Source 210 and seismic detectors 250 (only two labeled in FIG. 2) are placed under the weathering layer 130, and are arranged such that seismic waves 220 emitted by source 210 propagate through layers 135 and the reservoir 140. The source and seismic detectors' arrangement (e.g., their depths) are determined based on reservoir's location (e.g., its depth) and characteristics of the subsurface formation surrounding the reservoir. The seismic detectors may be three-component (3C) geophones or 4C, i.e., a 3C geophone and a hydrophone, a distributed acoustic sensor (DAS), a fiber optic system or accelerometers, etc.

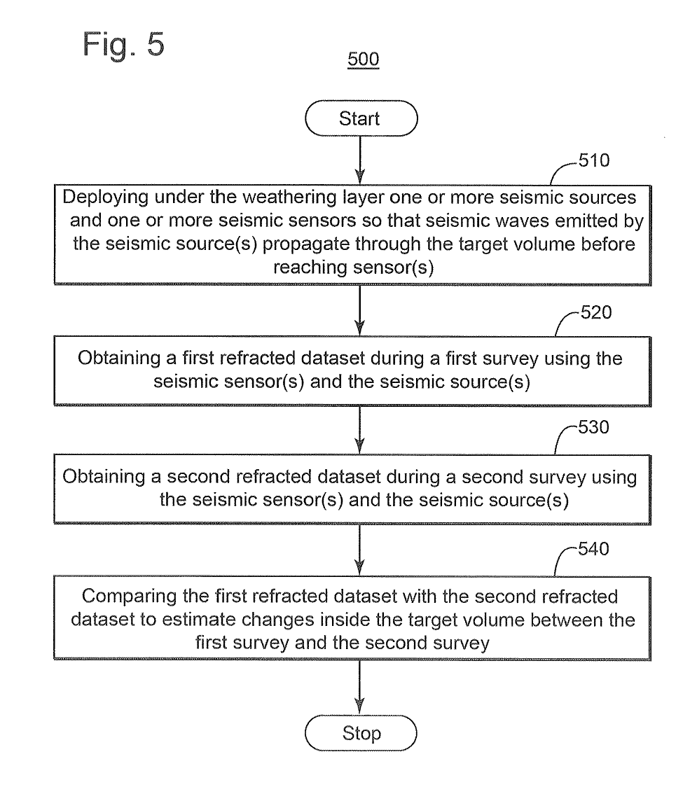

A possible seismic source to be used to generate the seismic waves in FIG. 2 may be a dipole with a long axis oriented along a vertical Y direction. Dipole sources are highly directional and emit both P-waves and S-waves as shown in FIG. 3. The radiation pattern is rotationally symmetric about the vertical axis. Maximum P-wave energy is emitted vertically, while none is emitted horizontally. Maximum S-wave energy is emitted at a 45° angle from vertical in both the upward and downward directions. No S-wave energy is emitted vertically or horizontally. Upward- and downward-emitted energies have opposite polarities.

Returning now to FIG. 2, waves 220 are subject to critical refraction at the reservoir's bottom surface 145, and then propagate substantially parallel to one another as waves 225 (only two labeled in FIG. 2) from surface 145 (under the reservoir or even the reservoir's bottom surface) to the seismic detectors 250. In contrast, seismic waves 224 (only two labeled in FIG. 2 and represented using dashed lines), which are reflected from the surface 145 (incidence angle equals reflection angle), have different angles with a horizontal direction if the seismic detectors are at different distances from the seismic source. Note that since the seismic wave propagation velocity in a hard rock layer under the reservoir is typically large, it is likely critical refraction will occur at the interface with such a layer. However, the interface where the critical refraction occurs may be a surface other than the reservoir's bottom surface.

The refracted datasets may be related to detected P-waves or to detected S-waves. The seismic source(s) and the seismic detector(s) may also be placed on or under the seafloor.

A time interval between surveys may be one or a few days up to weeks, months or years. In one embodiment, survey data may be acquired continuously to promptly observe any relevant changes. For example, data gathered each hour may be compared with older data to identify whether changes have occurred. During and/or after a survey is performed, detection data is collected and assembled to form a seismic dataset, for example by a data processing unit 260. Thus, when the target volume is monitored continuously, the second survey is performed immediately (i.e., a short time) after the first survey.

Data processing unit 260 may also be configured to compare refraction seismic data acquired during different surveys using monitoring system 200. Seismic data processing unit 260 may be located geographically close to the sources and receivers of the monitoring system 200, or it may be remote. In one embodiment, seismic data processing may be performed partially by an on-site data processing unit, and later completed by a remote data processing unit. For example, the on-site data processing unit may gather and assemble seismic datasets from data/signals supplied by the seismic detectors, and the remote data processing unit may compare the refracted datasets corresponding to different surveys. Intermediate processing, such as extracting reflected datasets from seismic datasets, may be performed either by the on-site data processing unit or by the remote data processing unit. In one embodiment, all processing may be performed as soon as possible to assist in oil and gas production.

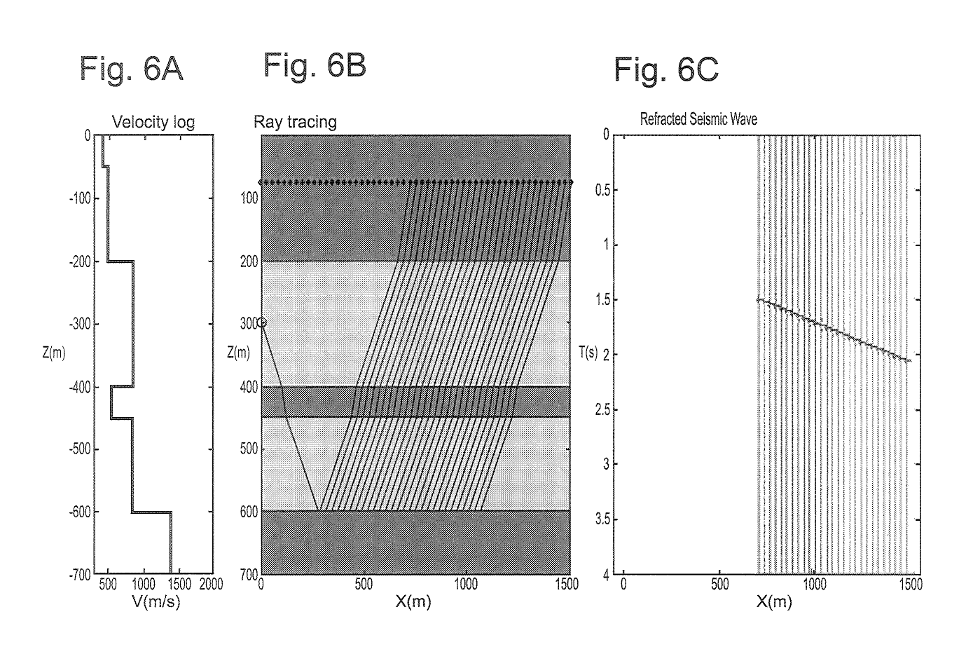

FIG. 4 illustrates a block diagram of a seismic data processing unit 400 usable in the FIG. 2 survey system according to an embodiment. Hardware, firmware, software or a combination thereof may be used to perform the various steps and operations. Unit 400 includes one or more data processors 410, coupled to an interface 420 and a memory 430.

Interface 420 may include one or more user interface mechanisms such as a mouse, keyboard, microphone, touch pad, touch screen, voice-recognition system, etc.

Data processor(s) 410 may be controlled by a user via interface 420 (i.e., data processing parameters may be input by the user via the interface). Data processor(s) 410 is/are configured to receive seismic datasets obtained during different surveys (e.g., using a seismic survey system like the one illustrated in FIG. 2), to extract refracted datasets from seismic datasets, and to compare the refracted datasets in order to estimate changes inside the target volume between the surveys.

In one embodiment, data processor(s) 410 may also be configured to extract reflected datasets from seismic datasets, and to compare the reflected datasets in order to enhance an initial estimate of the evolution of the target volume obtained from comparing the refracted datasets.

Interface 420 may further include a display, which may be any type of known display or presentation screen, such as LCD, plasma displays, cathode ray tubes (CRT), etc. Data processor(s) 410 may control the display to show images of the target volume based on the refracted and/or reflected datasets or changes thereof.

Memory 430 may include a random access memory (RAM), a read-only memory (ROM), CD-ROM, removable media and any other forms of media capable of storing data. Memory 430 may store the seismic datasets, the refracted and/or reflected datasets and other data resulting from comparisons (e.g., images of the changes). Memory 430 may also store executable codes which, when executed on a processor, make the processor perform seismic data processing methods according to various embodiments described in this section.

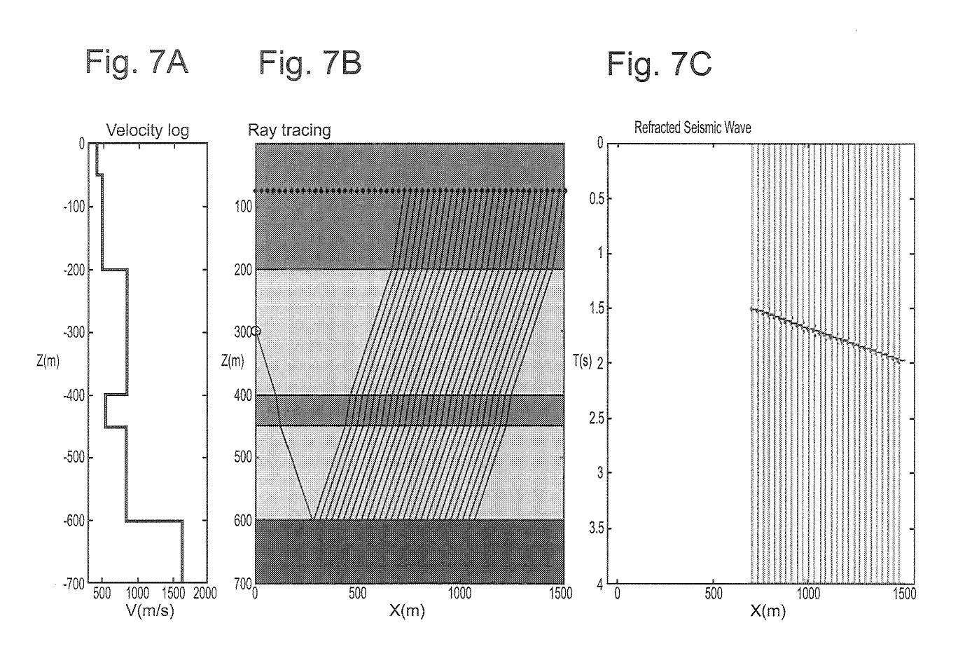

FIG. 5 is a flowchart of a method 500 for monitoring a target volume according to an embodiment. Method 500 includes deploying under the weathering layer one or more seismic sources and one or more seismic detectors so that seismic waves emitted by the one or more seismic sources propagate through the target volume before reaching the one or more seismic detectors, at 510. The seismic source(s) and the seismic detector(s) are arranged such that waves subject to critical refraction from a bottom surface of the reservoir (e.g., 140 in FIG. 2) reach the seismic detector(s). According to method 500, locations of the one or more seismic sources and of the one or more seismic detectors are the same for the first and second surveys. Refracted datasets may be related to detected P-waves (i.e., primary, compression waves) or to detected S-waves (i.e., secondary, shear waves) or any combined or converted waves.

Method 500 further includes obtaining a first refracted dataset during a first survey using the seismic detector(s) and the seismic source(s), at 520. Method 500 then includes obtaining a second refracted dataset during a second survey using the seismic detector(s) and the seismic source(s), at 530. In one embodiment, refracted datasets are obtained from seismic datasets using the timing of mono-frequency seismic signals emitted by the seismic source(s) (e.g., using the fact that refracted waves arrive to receiver(s) sooner after emission than the reflected waves). Traces (i.e., amplitude versus time corresponding to a horizontal location) may be reconstructed for the seismic datasets prior to extracting the refracted datasets, respectively. The refracted datasets may be extracted using one or more of a windowing method, a beam-forming method, a slant-stacking method, a migration method and a tomography method.

Method 500 then includes comparing the first refracted dataset with the second refracted dataset to estimate changes inside the target volume between the first and second surveys, at 540. Steps 530 and 540 may be repeated, the first refracted dataset being either the same for all repetitions, corresponding to the first survey in time, or changing at each repetition to correspond to the immediately previous survey. Surveys may be performed at regular time intervals, or continuously, a new survey starting shortly after a previous survey ended.

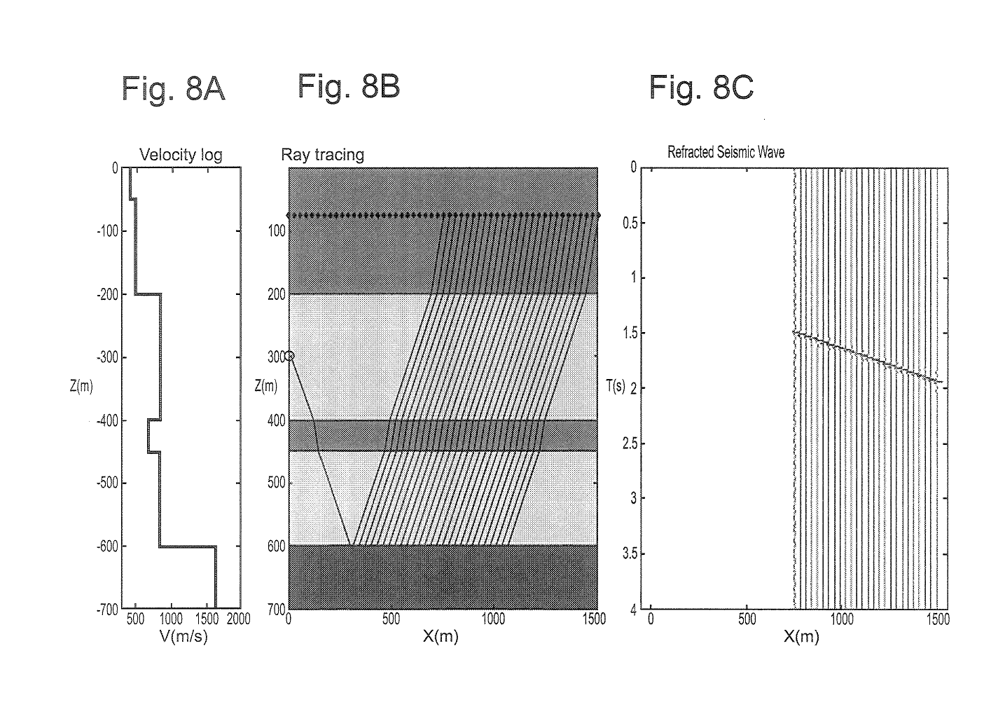

FIGS. 6A-C, 7A-C and 8 A-C illustrate how changes in wave propagation velocity can be observed in refracted datasets. FIGS. 6A-C illustrate a first simulated refracted dataset. FIG. 6A is a velocity log graph having on the horizontal axis the wave propagation velocity, v(m/s), and, on the vertical axis, the depth, z(m). FIG. 6B is a graph representing wave (ray) tracing through the layers; this graph has, on the vertical axis, the depth z(m), and, on the horizontal axis, the distance x(m), between the source (which is placed at 300 m depth) and seismic detectors (which are placed at 75 m depth). This arrangement of the source and the detectors is exemplary and not intended to be limiting, the actual depths and positions being determined from case to case. At each layer interface, the direction of the seismic wave changes according to Snell's law, due to the change in propagation velocity. At the interface at 600 m depth, critical refraction occurs, so that the wave propagating through the layer above this interface (which layer is characterized by a wave propagation velocity of about 800 m/s) does not penetrate inside the layer under the interface (which layer is characterized by a wave propagation velocity of about 1,400 m/s). FIG. 6C is a graph representing traces generated using this refracted seismic dataset; in this graph, the vertical axis represents the time, T(s), from the moment when the wave was generated, and the horizontal axis is the distance, x(m), from the source to the seismic detector. Note that time along the graph in Figure C is correlated to the depth in the graphs illustrated in FIGS. 6A and 6B. The substantially vertical lines on the graph in FIG. 6A represent amplitudes of the signals detected by seismic detectors at the different positions as a function of time. Along each of these substantially vertical lines on this graph, large amplitudes are detected when the refracted waves reach the seismic detectors. In FIGS. 6B and 6C graphs, one can observe that the closest detector that detects a refracted wave is located about 700 m from the source. According to the Figure C graph, this first detection occurred about 1.5 s after the source fired.

FIGS. 7A-C illustrate a second simulated refracted dataset using the same type of graphs as in FIGS. 6A-C. The source and receivers are placed at the same positions as for the first refracted dataset, but the wave propagation velocity characterizing the layer under the interface at 600 m depth is about 1,700 m/s instead of about 1,400 m/s. This change in wave propagation velocity causes a change in slope (i.e., dt/dx) in FIG. 7C graph compared to the similar graph in FIG. 6C.

FIGS. 8A-C illustrates a third simulated refracted dataset using the same type of graphs as in FIGS. 6A-C and 7A-C. The source and receivers are placed at the same positions as for the first and second refracted datasets, with the wave propagation velocity of about 1,700 m/s characterizing the layer under the interface at 600 m depth, as for the second dataset. However, unlike the first and second datasets, the wave propagation velocity characterizing a layer between 400 and 450 m is about 700 m/s for the third dataset instead of the about 500 m/s for the first and second datasets. This change in wave propagation velocity causes a slight decrease (offset) of the detection times in FIG. 8C graph compared to FIGS. 6C and 7C. Also, the first seismic detector receiving a refracted wave is located at 725 m (a slightly greater distance than for the first and second datasets).

In comparing refracted datasets, one or more of a difference method, a cross-correlation method, and/or a tomography differences method may be employed.

Method 500 may further include extracting complementary information about the evolution of the target volume by performing an inversion using additional information (e.g., using velocity logs from the reservoir, etc.).

Seismic data acquired during different surveys also includes reflected data besides the refracted data and noise. Surveys aiming to use refracted data are typically shorter, and therefore may not include enough reflected data to substantially enhance the signal over the noise. Nevertheless, reflected data carries significant information about the underground formation. Thus, method 500 may also further include extracting reflected datasets from seismic datasets and comparing the reflected datasets to enhance an initial estimate of changes inside the target volume obtained from comparing the refracted datasets.

In one embodiment, method 500 includes performing a full inversion of the first and second refracted datasets using iterative migration of a full waveform inversion.

The seismic source(s) and seismic detector(s) may be configured to record seismic data continuously, with the time intervals corresponding to the first and second surveys, respectively, being defined during processing so as to observe and evaluate significant changes inside the target volume.

Although method 500 has been discussed in terms of two surveys, two seismic datasets and two refracted datasets, it should be understood that a third (or further) refracted dataset may be obtained from seismic data acquired during a third survey and other subsequent surveys using the seismic source(s) and the seismic detector(s). The third (and following) survey(s) may be compared with any of the previously acquired refracted dataset(s).

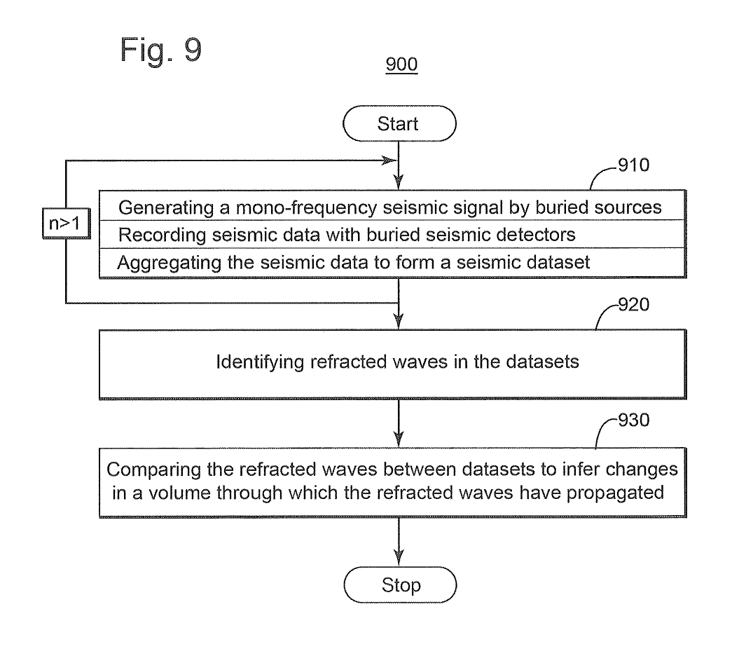

A flowchart of a method 900 for monitoring a target volume according to another embodiment is illustrated in FIG. 9. Method 900 first includes repeatedly (i.e., more than once as suggested by n>1) performing operations 910:

generating a mono-frequency seismic signal by buried sources,

recording seismic data with buried seismic detectors, and

aggregating the seismic data to form a seismic dataset.

In one embodiment, mono-frequency emissions may occur according to a predefined table of frequencies to be emitted and the timing of emitting each of the frequencies. In another embodiment, mono-frequency portions are emitted one after another like a sweep through the table until all the frequencies are covered. The table may also include information regarding which source of multiple sources to fire a predetermined frequency at a predetermined time (relative to a time reference), so that different sources are always firing different mono-frequencies, but the end result is that the full table/spectra is emitted and can be later reconstructed by inverse Fourier Transform.

Method 900 then includes identifying refracted waves in the datasets at 920, and comparing the refracted waves between datasets to infer changes in a volume through which the refracted waves have propagated at 930. Identification of the waves may be performed by windowing, beam-forming, slant-stacking, migration, and/or tomography. Comparing the waves between datasets may be based on differences among corresponding traces, cross-correlation and/or tomography differences. Inferring complementary information may be achieved by performing reservoir inversion using a prior information such as logs, a geological model, etc. Wave travel time and detected signals' amplitude variations (traces) are compared.

In one embodiment, method 900 may include identifying reflected waves in the datasets, and comparing the reflected waves identified in the datasets. The results of comparing the reflected waves and of comparing the refracted waves may be combined to infer additional information about changes in the volume through which the waves have propagated.

The disclosed exemplary embodiments provide methods and systems that monitor a target volume using refracted datasets. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A method for monitoring a target volume, the method comprising:
deploying one or more seismic sources and one or more seismic detectors under the weathering layer so that seismic waves emitted by the one or more seismic sources propagate through the target volume before reaching the one or more seismic detectors;
obtaining a first refracted dataset during a first survey using the one or more seismic detectors and the one or more seismic sources;
obtaining a second refracted dataset during a second survey using the one or more seismic detectors and the one or more seismic sources; and
comparing the first refracted dataset with the second refracted dataset to estimate changes inside the target volume between the first survey and the second survey,
wherein locations of the one or more seismic sources and of the one or more seismic detectors are the same for the first survey and for the second survey.

2. The method of claim 1, wherein the target volume is monitored continuously, the second survey being performed immediately after the first survey.

3. The method of claim 1, wherein
the first refracted dataset is obtained by
generating a first mono-frequency seismic signal at an instant by the one or more seismic sources,
recording a first seismic dataset with one or more seismic detectors in response to the first mono-frequency seismic signal, and
extracting the first refracted dataset from the first seismic dataset; and
the second refracted data is obtained by
generating a second mono-frequency seismic signal at another instant by the one or more seismic sources,
recording a second seismic dataset with the one or more seismic detectors in response to the second mono-frequency seismic signal, and
extracting the second refracted dataset from the second seismic dataset.

4. The method of claim 3, wherein the one or more seismic sources and one or more seismic detectors are arranged such that the first and second refracted datasets to correspond to a critical refraction angle from a reservoir bottom surface.

5. The method of claim 3, wherein the first and second refracted datasets are extracted using one or more of a windowing method, a beam forming method, a slant stacking method, a migration method and a tomography method.

6. The method of claim 3, further comprising:
extracting a first reflected dataset from the first seismic dataset;
extracting a second reflected dataset from the second seismic dataset; and
comparing the first reflected dataset with the second reflected dataset to enhance an initial estimate of the changes inside the target volume obtained from comparing the first refracted dataset with the second refracted dataset.

7. The method of claim 1, wherein the comparing of the first refracted dataset with the second refracted dataset includes one or more of a difference method, a cross-correlation method, and/or a tomography differences method.

8. The method of claim 1, further comprising:
extracting complementary information about an evolution of the target volume by performing an inversion using additional information.

9. The method of claim 1, further comprising:
performing a full inversion of the first and second refracted datasets using any waveform inversion method.

10. The method of claim 1, the method further comprising:
obtaining a third refracted dataset during a third survey using the one or more seismic detectors and the one or more seismic sources; and
comparing the third refracted dataset with at least one of the first refracted dataset and the second refracted dataset.

11. The method of claim 1, wherein the one or more seismic sources and the one or more seismic detectors are operated to continuously record seismic data, time intervals corresponding to the first and second surveys being defined during data processing.

12. The method of claim 1, wherein the first and second refracted datasets are related to detected P-waves.

13. The method of claim 1, wherein the first and second refracted datasets are related to detected S-waves.

14. A monitoring system, comprising:
one or more seismic sources and one or more seismic detectors deployed so that seismic waves emitted by the one or more seismic sources propagate through a target volume before reaching the one or more seismic detectors;
a seismic data processing unit configured
to receive a first seismic dataset obtained during a first survey using the one or more seismic detectors and the one or more seismic sources, and a second seismic dataset obtained during a second survey using the one or more seismic detectors and the one or more seismic sources,
to extract a first refracted dataset from the first seismic dataset and a second refracted dataset from the second seismic dataset, and
to compare the first refracted dataset with the second refracted dataset to estimate an evolution of the target volume,
wherein locations of the one or more seismic sources and of the one or more seismic detectors are not changed between the first survey and the second survey.

15. The system of claim 14, wherein the seismic data processing unit is further configured
to extract a first reflected dataset from the first seismic dataset and a second reflected dataset from the second seismic dataset; and
to compare the first reflected dataset with the second reflected dataset to enhance an initial estimate of the evolution of the target volume obtained from comparing the first refracted dataset with the second refracted dataset.

16. The system of claim 14, wherein the locations of the one or more seismic sources and one or more seismic detectors are placed below the weathering layer.

17. The system of claim 14, wherein the seismic data processing unit is configured to extract the first and second refracted datasets so as to correspond to a critical refraction from a predetermined surface inside the target volume.

18. The system of claim 14, wherein the one or more seismic sources and one or more seismic detectors are buried under the seafloor.

19. A non-transitory computer readable medium storing executable codes which, when executed by a processor that receives a first seismic dataset obtained during a first survey using the one or more seismic detectors and the one or more seismic sources arranged so that seismic waves emitted by the one or more seismic sources travel through a target volume before reaching the one or more seismic detectors, and a second dataset obtained during a second survey using the one or more seismic detectors and the one or more seismic sources which have the same location as during the first seismic survey, makes the processor perform a method comprising:
extracting a first refracted dataset from the first seismic dataset and a second refracted dataset from the second dataset; and
comparing the first refracted dataset with the second refracted dataset to estimate changes that occurred inside the target volume between the first survey and the second survey.

20. The non-transitory computer readable medium of claim 19, wherein the method further comprises:
extracting a first reflected dataset from the first seismic dataset and a second reflected dataset from the second seismic dataset; and
comparing the first reflected dataset with the second reflected dataset to enhance an initial estimate of the evolution of the target volume obtained from comparing the first refracted dataset with the second refracted dataset.
